(19) United States
(12) Patent Application Publication
(10) Pub. No.: US 2002/0112957 A1
(43) Pub. Date: Aug. 22, 2002

(54) Low mass protective layer

(76) Inventors: Eric P. Clyde, Bay City, MI (US); Paul Kikuchi, Fenton, MI (US); Richard F. Beckmeyer, Davisburg, MI (US); William J. LaBarge, Bay City, MI (US)

Correspondence Address: VINCENT A. CICHOSZ, DELPHI TECHNOLOGIES, INC., Legal Staff, P.O. Box 5052 Mail Code: 480-414-420, Troy, MI, 48007-5052, US

(21) Appl. No.: 09/737,519

(22) Filed: Dec. 15, 2000

(51) Int. Cl. G01N 27/407

(52) U.S. Cl. 204/426

(57) ABSTRACT

A sensor comprising an electrochemical cell (sensing electrode, reference electrode, and electrolyte disposed therebetween) has a protective silica coating at least on a side of the sensing electrode opposite the electrolyte. This protective silica coating can be an aerogel which is optionally also disposed on a side of the reference electrode opposite the electrolyte.

### TECHNICAL FIELD

The present invention relates to exhaust sensors, and particularly to sensors with a porous protective layer for protection of the sensor electrode from poisoning.

### BACKGROUND OF THE INVENTION

Oxygen sensors are used in a variety of applications that require qualitative and quantitative analysis of gases. In automotive applications, the direct relationship between oxygen concentration in the exhaust gas and air to fuel ratio (A/F) of the fuel mixture supplied to the engine allows the oxygen sensor to provide oxygen concentration measurements for determination of optimum combustion conditions, maximization of fuel economy, and management of exhaust emissions.

A conventional oxygen sensor consists of an ionically conductive solid electrolyte, a sensing electrode on the sensor's exterior, which is exposed to the exhaust gases, a porous protective layer disposed over the sensing electrode, and a reference electrode on the sensor's interior surface exposed to a known oxygen partial pressure. Sensors typically used in automotive applications use a yttria stabilized, zirconia based electrochemical galvanic cell with porous platinum electrodes operating in potentiometric mode to detect the relative amounts of oxygen present in an automobile engine's exhaust. When opposite surfaces of this galvanic cell are exposed to different oxygen partial pressures, an electromotive force is developed between the electrodes on the opposite surfaces of the zirconia wall, according to the Nernst equation:

$$E = ( \frac{RT}{4 F} ) ln ( \frac{{P}_{{O}_{2}}^{ref}}{{P}_{{O}_{2}}} )$$

$$\begin{matrix}where : E = electromotive force \\ R = universal gas constant \\ F = Faraday constant \\ T = absolute temperature of the gas \\ {P}_{{O}_{2}}^{ref} = oxygen partial pressure of the reference gas \\ {P}_{{O}_{2}} = oxygen partial pressure of the exhaust gas\end{matrix}$$

Such sensors indicate qualitatively whether the engine is operating in fuel rich or fuel lean conditions, without quantifying the actual air to fuel ratio of the exhaust mixture.

During use, an oxygen sensor operates in a heated gaseous mixture, such as an exhaust gas that contains various compounds such as hydrocarbons, carbon monoxide, nitrogen oxides, silica, lead and the like. These compounds permeate and pass through the pores of the protective layer to the surface of the sensing electrode. The silica, lead, and some other contaminants in the exhaust gas can poison the sensing electrode, causing deterioration of the sensor output and its response properties. A stable and porous protective coating is therefore frequently employed on the outside of the exposed electrode layer. This coating also protects the sensing electrode against detrimental physical and chemical influences. It acts as a mechanical shield to prevent gas and particulate-induced erosion of the electrode and as a filter to reduce the rate at which poisoning from silica, lead and other harmful compounds from the exhaust stream can occur.

This protective coating can be formulated to promote equilibrium reactions between oxygen and oxidizable substances such as carbon monoxide, hydrocarbons and the like. The protective coating is made from materials that are heat-resistant and chemically stable such as, for example, aluminum oxide and/or zirconium oxide. Sometimes, these materials are admixed with other materials such as, for example, platinum, palladium, ruthenium, iridium and/or other oxides that have a catalytic effect on the aforementioned equilibrium reactions.

In addition to acting as a filter, mechanical shield, and equilibrium reaction promoter, the protective coating can accentuate “lean shift”. Due to the large difference in oxygen partial pressures between fuel rich and fuel lean exhaust conditions, the electromotive force changes sharply at the stoichiometric point, giving rise to the characteristic switching behavior of oxygen sensors. Lean shift is a phenomenon in which unreacted gases resulting from incomplete combustion cause the sensor to switch at an air/fuel ratio that is greater than the true stoichiometric point (i.e., under a rich condition). Lean shift of the sensor's switch point is caused by the faster diffusion of hydrogen as compared to oxygen through the porous protective layer covering the sensing electrode.

Conventional protective coatings have been varied in size and/or composition in an attempt to improve their properties. For example, thicker protective coatings have been employed to prevent electrode poisoning. However, this process has not yielded the best results since the poisoning compounds that pass through as particulates or in a gaseous form clog the pores of the protective layer, resulting in poor performance of the sensing electrode. An alternative conventional approach to inhibit poisoning is to apply multiple layers of a protective coating of heat-resistant metal oxides such as alumina, calcia, and the like on the protective layer. However, the multiple protective layers change the performance of the sensor and provide limited poison protection.

While suitable for their intended purposes, it has been found that sensors are still poisoned even when such protective coatings are used. Accordingly, there remains a pressing need in the art for a protective layer which will enhance sensor performance.

### SUMMARY OF THE INVENTION

The drawbacks and disadvantages of the prior art are overcome by the sensor and method for forming the sensor. The sensor comprises: a sensing electrode; a reference electrode; an electrolyte disposed between and in ionic communication with a first side of the sensing electrode and a first side of the reference electrode; and a silica protective layer disposed on a second side of the sensing electrode.

The method of forming the sensor comprises: disposing a first electrical lead in electrical communication with a sensing electrode; disposing a second electrical lead in electrical communication with the reference electrode; disposing an electrolyte between a first side of the sensing electrode and a first side of the reference electrode; disposing a silica protective layer adjacent the second side of the sensing electrode to form the sensor.

The above-discussed and other features and advantages will be appreciated and understood by those skilled in the art from the following detailed description and drawings.

### BRIEF DESCRIPTION OF THE DRAWINGS

The gas sensor and protective layer will now be described, by way of example, with reference to the following figures, which are meant to be exemplary, not limiting, and in which:

FIG. 1 is one embodiment of an oxygen sensor.

### DESCRIPTION OF THE PREFERRED EMBODIMENT

Disclosed herein is a protective layer for sensors, in particular oxygen sensors, comprising a layer of porous silica. Although described in connection with an oxygen sensor, it is to be understood that the sensor could be a nitrogen oxide sensor, hydrogen sensor, hydrocarbon sensor, or the like. Furthermore, while oxygen is the reference gas used in the description disclosed herein, it should be understood that other gases could be employed as a reference gas.

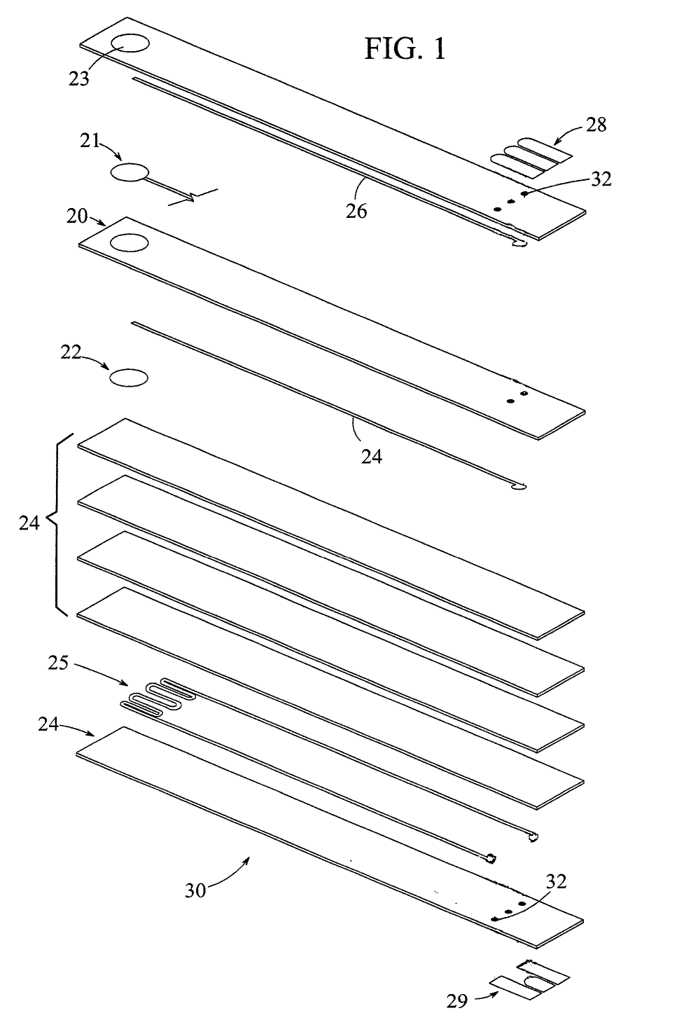

Preferably, the sensor according to one embodiment is configured according to FIG. 1. FIG. 1 shows a sensor (30) with an ionically conductive solid electrolyte (20), a sensing electrode (21) disposed on one side of the electrolyte (20), between the electrolyte (20) and a porous protective layer (23). On the opposite side of the electrolyte (20) is a reference electrode (22) Meanwhile, disposed across the electrolyte (20), in electrical communication with the sensing electrode (21) and the reference electrode (22), respectively, are electrical leads (26,27) On the second side of the reference electrode (22) are support layers (24), and a heater (25). Finally, the outer sides of the sensor (30), at the end opposite the electrodes (21,22) and electrolyte (20), are contacts (28,29) which electrically connect to the leads (26,27) and heater (25) through vias (32). A protective layer (not shown) may also be formed on the second side of the reference electrode (22). Additionally, other sensor components may be employed such as a pumping cell, reference chamber, lead gettering layer, ground plane, porous electrolyte, and the like, as is conventionally known in the art.

The support layers (24), heater (25), contacts (28,29) and leads (26,27), can be composed of materials conventionally used in exhaust sensors. For example, the support layers (24) can comprise a dielectric material such as a metal oxide, e.g., alumina, while the heater (25), contacts (28,29) and leads (26,27) can comprise a thermally and electrically conductive metal such as platinum, palladium, ruthenium, and the like, and other metals, metal oxides, and alloys and mixtures comprising at least one of the foregoing metals.

The solid electrolyte (20) can be formed of any material that is capable of permitting the electrochemical transfer of oxygen ions while inhibiting the passage of exhaust gases. Possible solid electrolyte materials include conventionally employed materials such as zirconia, ceria, calcia, yttria, lanthana, magnesia, and the like, as well as combinations comprising at least one of the foregoing electrolyte materials, such as yttria doped zirconia and the like.

Disposed adjacent to the solid electrolyte (20) are electrodes (21, 22). The sensing electrode (21), which is exposed to the exhaust gas during operation, preferably has a porosity sufficient to permit diffusion to oxygen molecules therethrough. Similarly, the reference electrode (22), which is typically exposed to a reference gas such as oxygen, air, or the like, during operation, preferably has a porosity sufficient to permit diffusion to oxygen molecules therethrough These electrodes can comprise any metal capable of ionizing oxygen, including, but not limited to, noble metals such as platinum, palladium, gold, osmium, rhodium, iridium and ruthenium; and metal oxides, such as zirconia, yttria, ceria, calcia, alumina, and the like; as well as combinations comprising at least one of the foregoing metals and metal oxides.

Disposed on the exterior side of the sensing electrode (21) is a protective coating layer (23) which protects the sensing electrode (21) from impurities that cause poisoning of the electrode. Preferably, the protective coating comprises a first layer of spinel (e.g., magnesium aluminate), alumina, zirconia, or a combination comprising at least one of the foregoing layers, with an aluminazirconia layer preferred. This coating also comprises a second layer comprising silica with a silica aerogel (also known as a silica xerogel) preferred. The first layer preferably comprises a low porosity, e.g., less than about 5%, less than with about 3% preferred, and about 1% to about 2% especially preferred. Meanwhile, the second layer preferably has a porosity of about 8% or greater, with about 10% or greater preferred. An aerogel is a special class of open-celled foam that has ultrafine cell and pore size, high surface area and a solid matrix composed of interconnected colloidal-like particles or polymeric chains.

The initial surface area of the silica aerogel, i.e., the surface area prior to aging, is preferably greater than about 300 square meters per gram (m²/g), with greater than about 400 m²/g more preferred, greater than about 600 m²/g even more preferred, and about 800 m²/g or greater most preferred; with surface areas up to about 1,800 m²/g or so possible. Post aging (e.g., exposure to exhaust gas at temperature excursions up to 925° C., with up to about 800° C. common), the silica aerogel preferably has a surface area exceeding about 300 m²/g, with about 450 m²/g or greater preferred, and about 600 m²/g or greater especially preferred. Preferably, the silica comprises a mixture of particle sizes and shapes, e.g., coarse particles having a particle size exceeding about 8 microns (μ), with about 10 μto about 25 μpreferred, and fine particles having a particle size of less than about 5 μ, with a particle size of about 2 μor less preferred, and about 1 micron to about 2 microns especially preferred, to enable the fine particles to fill the voids between the larger particles. Additionally, at least some of the particles are preferably hollow spheres (e.g., about 5 wt % or greater, with about 10 wt % or greater preferred, based upon the total weight of the silica coating).

The density of the silica aerogel is typically greater than about 0.001 kilogram per cubic meter (kg/m³), with about 0.001 kg/m³ to about 1.0 kg/m³ preferred, with about 0.002 kg/m³ to about 0.9 kg/m³ more preferred, and about 0.003 kg/m³ to about 0.8 kg/m³ most preferred.

In one embodiment, an alumina coating is about 100 microns thick and weighs about 100 milligrams (mg). In contrast, an aerogel coating about 100 microns thick weighs less than 5 mg. The silica aerogels are hydrophobic so no water absorbs on the surface. The light-off times of a sensor with an aerogel coating is at least 3 seconds faster than a sensor with an alumina coating. Three additional seconds doesn't sound like much, but the time it takes for the sensor to light off, about 22 seconds total, is long enough to emit enough hydrocarbons to fail the FTP test for ULEV emission levels.

In order to sufficiently inhibit sensor poisoning, the protective layer preferably has a porosity, pore size, and thickness to inhibit contaminant access to the sensing electrode, while not significantly adversely effecting the flow of oxygen there through. Although the protective layer (23) can have a thickness exceeding about 0.30 millimeters (mm), a thickness up to about 0.15 mm is typically employed, with a thickness of about 0.05 mm to about 0.14 mm preferred, and about 0.08 mm to 0.12 mm most preferred. Meanwhile, the protective coating typically has a pore size of less than about 1,000 Å, with less than about 800 Å preferred, and less than about 500 Å especially preferred

The protective layer (23), which is disposed on at least the sensing electrode (21) side of the sensor, can be produced by any conventional method. For example, the protective layer can be produced by forming an aerogel by exposing a precursor (such as tetramethyl orthosilicate (TMOS, Si(OCH₃)₄), tetraethyl orthosilicate (TEOS, Si(OCH₂CH₃)₄), and the like, as well as combinations comprising at least one of the foregoing precursors), to water vapor and optionally drying the aerogel. A slurry can then be formed by soaking the aerogel in an organic based solution containing one or more noble metal (e.g., platinum, palladium, ruthenium, osmium, iridium, rhodium, and the like) compounds, such as tetraamine palladium II chloride (Pd(NH₃)₄Cl₂), diamine palladium II hydroxide (Pd(NH₃)₂(OH)₂), palladium 2-ethylhexanoate, platinum 2-ethylhexanoate, and the like, as well as combinations comprising at least one of the foregoing noble metal compounds. The sensor is dipped into the slurry, dried, and calcined, typically to temperatures of about 400° C., or so, fixing the noble metal around the outer perimeter of the aerogel sphere.

Essentially, the other sensor components, e.g., electrodes (21,22), electrolyte (20), support layers (24), heater (25), leads (26,27), vias (32), contacts (28,29), lead gettering layer, ground plane, porous electrolyte, pumping cell, fugitive material (reference chamber), and the like, are formed using conventional techniques such as tape casting methods, sputtering, punching and place, spraying, (e.g., electrostatically spraying, slurry spraying, plasma spraying, and the like), dipping, painting, and the like. The components are then laid-up in accordance with the particular type of sensor. The sensor is then heat treated to laminate the layers together. Typically, the sensor is heated to a temperature of about 1475° C. to about 1550° C. for a sufficient period of time to fully fire the layers, with a temperature of about 1490° C. to about 1510° C. preferred, for a period of up to about 3 hours or so, with about 100 minutes to about 140 minutes preferred. After the part has cooled, a coating of the silica aerogel can be applied. The part is typically dipped in a suspension of aerogel particles to coat one or both sides of the sensor. The part is then calcined to about 400° C. or so.

A number of advantages accrue to the use of silica, especially silica aerogel, as a protective layer. Silica, for example, is hydrophobic (unlike alumina, which is hydroscopic). A silica protective layer comprising about 40 milligrams (mg) to about 50 mg of silica will absorb about 5 mg of water, while an alumina coating comprising about 40 mg to about 50 mg of alumina will absorb about 30 mg of water. Furthermore, even without water adsorption, the silica coatings are lighter than alumina coatings. For example, an alumina coating that is 50 microns thick weighs about 40 mg while a silica coating that is 50 microns thick weighs only about 5 mg.

Further, alumina has a low surface area when compared to silica. For example, the surface area of a typical alumina coating is about 50 m²/g while the surface area of the same size silica aerogel coating is about 900 m²/g. This high surface area leads to better protection for the sensing electrode due to higher adsorption activity of the coating. Since the coating is more reactive for inorganic acid gasses, there is a better chance of reactivity with the coating before the poisonous gasses can reach the electrode. Furthermore, even after severe aging, e.g., in temperatures exceeding about 1,000° C., the silica aerogel maintains a surface area exceeding about 100 m²/g, with a surface area exceeding about 250 m²/g common, and a surface area of about 300 m²/g readily attainable. For example, the surface area of a typical alumina coating is reduced to below 10 m²/g, namely to about 3 m²/g, when the coating is exposed to temperatures above 1,140° C. In contrast, the surface area of a silica coating, is maintained above about 300 m²/g, even at 1,200° C., well beyond the temperature used on the alumina coating.

For example, as described earlier, the protective layer has an impact on the sensor's shift from rich to lean response time. In particular, the aerogel protective layer enhances the increase in shift from lean to rich response time while alumina does not affect sensor performance. Essentially, an ideal sensor has a rich to lean (RL) lean to rich (LR) ratio of about 1.0, because the sensor is well balanced and the easiest to calibrate for optimizing emissions. Comparing a spinel only (no alumina), as produced sample, to a spinel only (no alumina) hydrogen fluoride (HF) etched sample, it is evident that the HF treated sample (i.e., with silica contamination removed), has a faster LR time and an unaffected RL time. (See Table I) As a result the RL/LR ratio increases to 3.3. It is greatly desired that the ratio remain below 3.0. Current diagnostics consider a sensor with a ratio above 5.0 as a failed sensor. Future vehicle diagnostics will consider a sensor with a ratio above 3.0 as a failed sensor and a “fix engine now” light will appear to the driver. Sensors with no alumina coating can take very little silica poisoning.

TABLE I

| | Silica Aging | RL Time | LR Time | |
|---|---|---|---|---|
| Coating | (hrs.) | (sec) | (sec) | RL/LR |
| spinel only HF² | — | 50 | 15 | 3.3 |
| spinel only¹ | 0 | 51 | 23 | 2.2 |
| | 0 | 51 | 28 | 2.2 |
| | 10 | 2312 | 251 | failed |

¹spinel coating as produced
²spinel coating with hydrogen fluoride etch

Sensors with alumina coatings, Samples a, b and c, have some silica poisoning after 96 hours (see Table II). Samples a and b have higher LR values with about unchanged RL values. Sample c has a thinner alumina coating (about 50 mg alumina) than a or b (about 100 mg alumina). Sample c has higher RL as well as LR times and is beginning to poison. There is an amount of silica poisoning that is beneficial to the sensor as demonstrated by samples with coating a and b. There is a further amount that hurts the sensor as demonstrated by no coating or coating c, a light coating. Coatings with aerogels and xerogels that yield slight silica contamination demonstrated by aerogel coating d and xerogel coating e, immediately have the beneficial sensor characteristics that coatings a and b have only after 96 hours silica poisoning. For example, silica can increase the lean to rich response time to an extent where the ratio between the lean to rich and rich to lean response time is about 1.

TABLE II

| | Silica Aging | RL Time | LR Time | |
|---|---|---|---|---|
| Sample | (hrs.) | (sec) | (sec) | RL/LR |
| a | 0 | 62 | 28 | 2.2 |
| | 96 | 67 | 67 | 1.0 |
| | 96 (HF)¹ | 58 | 24 | 2.6 |
| b | 0 | 55 | 21 | 2.6 |
| | 96 | 59 | 49 | 1.2 |
| | 96 (HF)¹ | 52 | 23 | 2.3 |
| c | 0 | 60 | 25 | 2.4 |
| | 96 | 84 | 105 | 0.8 |
| | 96 (HF)¹ | 53 | 27 | 1.9 |
| d² | 0 | 60 | 75 | 0.8 |
| e² | 0 | 64 | 81 | 0.8 |

¹hydrogen fluoride etch
²aerogel coating

Essentially, this invention overcomes some of the shortcomings that exist in the prior art sensors because the silica protective layer has a lower mass than conventional alumina sensors, higher surface area than conventional alumina sensors, is hydrophobic, and has a slower lean to rich shift response time and faster light-off than conventional alumina sensors.

While preferred embodiments have been shown and described, various modifications and substitutions may be made thereto without departing from the spirit and scope of the invention. Accordingly, it is to be understood that the present invention has been described by way of illustration only, and such illustrations and embodiments as have been disclosed herein are not to be construed as limiting to the claims.

What is claimed is:

1. A sensor, comprising:
a sensing electrode;
a reference electrode;
an electrolyte disposed between and in ionic communication with a first side of the sensing electrode and a first side of the reference electrode; and
a silica protective layer disposed on a second side of the sensing electrode.

2. The sensor of claim 1, wherein the protective layer comprises multiple layers of silica.

3. The sensor of claim 1, wherein the silica is an aerogel.

4. The sensor of claim 3, wherein the surface area of the silica is about 300 m²/g or greater.

5. The sensor of claim 4, wherein the surface area of the silica is about 400 m²/g or greater.

6. The sensor of claim 5, wherein the surface area of the silica aerogel is about 600 m²/g or greater.

7. The sensor of claim 6, wherein the surface area of the silica aerogel is about 800 m²/g or greater.

8. The sensor of claim 3, wherein post aging of the sensor in an exhaust gas at temperatures up to about 800° C., the surface area of the silica is about 300 m²/g or greater.

9. The sensor of claim 8, wherein the post aging surface area of the silica is about 450 m²/g or greater.

10. The sensor of claim 9, wherein the post aging surface area of the silica is about 600 m²/g or greater.

11. The sensor of claim 1, further comprising a silica protective layer disposed on a second side of the reference electrode.

12. The sensor of claim 1, wherein the silica comprises a mixture of coarse particles having a coarse particle size exceeding about 8 microns, and fine particles having a fine particle size of less than about 5 microns.

13. The sensor of claim 12, wherein the coarse particle size exceeds about 10 microns, and the fine particle size is less than about 2 microns.

14. The sensor of claim 13, wherein the coarse particle size exceeds about 25 microns and the fine particle size is about 1 micron to about 2 microns.

15. The sensor of claim 1, wherein the silica protective layer comprises hollow spheres.

16. The sensor of claim 15, wherein the silica protective layer comprises at least about 5 wt % hollow spheres based upon the total weight of the silica protective coating.

17. The sensor of claim 16, wherein the silica protective layer comprises at least about 10 wt % hollow spheres based upon the total weight of the silica protective coating.

18. The sensor of claim 1, wherein the silica protective layer further comprises a metal.

19. The sensor of claim 18, wherein the metal is selected from the group consisting of platinum, palladium, rhodium, osmium, iridium, rhodium, and combinations comprising at least one of the foregoing metals.

20. The sensor of claim 19, wherein the metal is palladium.

21. The sensor of claim 1, further comprising a second layer disposed between the silica protective layer and the sensing electrode, wherein the second layer is selected from the group consisting of spinel, alumina, zirconia, and combinations comprising at least one of the foregoing layers.

22. A method of forming a sensor, comprising:
disposing a first electrical lead in electrical communication with a sensing electrode;
disposing a second electrical lead in electrical communication with the reference electrode;
disposing an electrolyte between a first side of the sensing electrode and a first side of the reference electrode; and
disposing a silica protective layer adjacent the second side of the sensing electrode to form the sensor.

23. The method of forming a sensor as in claim 22, wherein the silica is an aerogel slurry.

24. The method of forming a sensor as in claim 23, wherein the surface area of the silica is about 300 m²/g or greater.

25. The method of forming a sensor as in claim 24, wherein the surface area of the silica is about 400 m²/g or greater.

26. The method of forming a sensor as in claim 25, wherein the surface area of the silica aerogel is about 600 m²/g or greater.

27. The method of forming a sensor as in claim 26, wherein the surface area of the silica aerogel is about 800 m²/g or greater.

28. The method of forming a sensor as in claim 21, wherein post aging of the sensor in an exhaust gas at temperatures up to about 800° C., the surface area of the silica is about 300 m²/g or greater.

29. The method of forming a sensor as in claim 28, wherein the post aging surface area of the silica is about 450 m²/g or greater.

30. The method of forming a sensor as in claim 29, wherein the post aging surface area of the silica is about 600 m²/g or greater.

31. The method of forming a sensor as in claim 22, further comprising disposing a second layer between the silica protective layer and the sensing electrode, wherein the second layer is selected from the group consisting of spinel, alumina, and combinations comprising at least one of the foregoing layers.
